(19) United States
(12) Patent Application Publication
(10) Pub. No.: US 2011/0173187 A1
(43) Pub. Date: Jul. 14, 2011

(54) CONFLICT OF INTEREST DETECTION SYSTEM AND METHOD USING SOCIAL INTERACTION MODELS

(75) Inventors: Hahn-Ming Lee, Taipei City (TW); Jan-Ming Ho, Taipei City (TW); Chiu-Yi Chen, Taipei City (TW); Chia-Hsin Huang, Taipei City (TW); Kai-Hsiang Yang, Taipei City (TW); Jerome Yeh, Taipei City (TW); Chieh-Hung Lin, Taipei City (TW); Shou-Wei Ho, Taipei City (TW)

(73) Assignee: NATIONAL TAIWAN UNIVERSITY OF SCIENCE & TECHNOLOGY, Taipei City (TW)

(21) Appl. No.: 12/850,597

(22) Filed: Aug. 4, 2010

(30) Foreign Application Priority Data
Jan. 14, 2010 (TW) TW99100883

(51) Int. Cl. G06F 17/30

(52) U.S. Cl. 707/722; 707/E17.014

(57) ABSTRACT

A conflict of interest detection system is provided. A data extractor retrieves a document and extracts author, title, and date information. A co-authorship finder finds out co-author relation among documents. A relevant group cluster identifies a key researcher in a particular field, and groups researchers connected to the key researcher as a group. A potential link finder identifies researchers who may have co-author relation. A relation filter filters out couples having weaker relation from the group having co-author relation. The filtered co-author relation data is then stored as a conflict of interest list.

### CROSS REFERENCE TO RELATED APPLICATIONS

This application claims priority of Taiwan Patent Application No. 099100883, filed on Jan. 14, 2010, the entirety of which is incorporated by reference herein.

### BACKGROUND OF THE INVENTION

1. Field of the Invention

The invention relates to information processing systems and methods, and in particular to a conflict of interest detection system using social interaction models.

2. Description of the Related Art

This section is intended to introduce the reader to various aspects of the art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read given said understanding, and not as admissions of prior art.

Detection for conflict of interest is widely utilized in varies fields. Searching and collecting documents is important for detection for conflict of interest in an academic world. Unfortunately, most researchers neglect the fact that in most cases data collected from a network is not complete. The incompleteness is due to reasons such as man-made mistakes, and privacy protection. Consequently, related party cannot be uncovered from an established academic collaboration network. In a case where an exact conflict of interest detection is required, incorrect results of conflict of interest detection might lead to an undesirable result.

Accordingly, a conflict of interest detection system and method is needed to address problems of the conventional method.

### BRIEF SUMMARY OF THE INVENTION

A detailed description is given in the following embodiments with reference to the accompanying drawings.

A conflict of interest detection system using social interaction models is provided. The conflict of interest detection system comprises: a data extractor retrieving a document from a digital library, and extracting author, title, and date information of the retrieved document; a publication database, storing the author, title, and date information of the document; a co-authorship finder, establishing co-authorship among documents stored in the publication database, and establishing co-author relation among authors corresponding to the document; a co-author relation database, storing the co-author relation information; a relevant group clustering device, identifying an authority in a particular field, and clustering researchers connected to the authority as a group, thereby researchers having potential co-author relation are grouped together; a potential link finder, identifying researchers having potential co-author relation from the groups established by the relevant group clustering device using at least one graph theory algorithm; a relation filter, filtering out researchers having weaker relation from the group having co-author relation established by the potential link finder, the filtering is implemented based on a number of common friends of the corresponding researchers, a number of collaborative papers, and a date of collaborative publications; and a conflict interest list, storing the filtered co-author relation data as the conflict of interest list.

A conflict of interest detection method using social interaction models is also provided. The conflict of interest detection method comprises steps of: providing a digital library for storing documents of a plurality of researchers, wherein the document comprises author and date information; storing the author and date information of the document in a publication database; establishing co-author relation among documents stored in the publication database, and storing the co-author relation in a co-author relation database; clustering researchers into a relevant group according to the relation between two of the researchers in the co-author relation database; identifying researchers having potential co-author relation or potential conflict of interest according to the relevant group; filtering out researchers having weaker relation from the group having co-author relation, the filtering is implemented based on a number of common friends of the corresponding researchers, a number of collaborative papers, and a date of collaborative publications; and outputting the filtered co-author relation data as a conflict of interest list.

### BRIEF DESCRIPTION OF THE DRAWINGS

The present invention can be more fully understood by reading the subsequent detailed description and examples with references made to the accompanying drawings, wherein:

FIG. 1 is a schematic view of an embodiment of a conflict of interest detection system of the present invention;

FIG. 2 is a schematic view showing the data extractor of FIG. 1;

FIG. 3 is a schematic view showing the co-authorship finder of FIG. 1;

FIG. 4 is a schematic view showing the relevant group clustering device of FIG. 1;

FIG. 5 is a schematic view showing the relation filter of FIG. 1;

FIG. 6 is a flowchart of an embodiment of a conflict of interest detection method of the present invention; and

FIG. 7 is a flowchart showing details of the step of relation filtering of FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

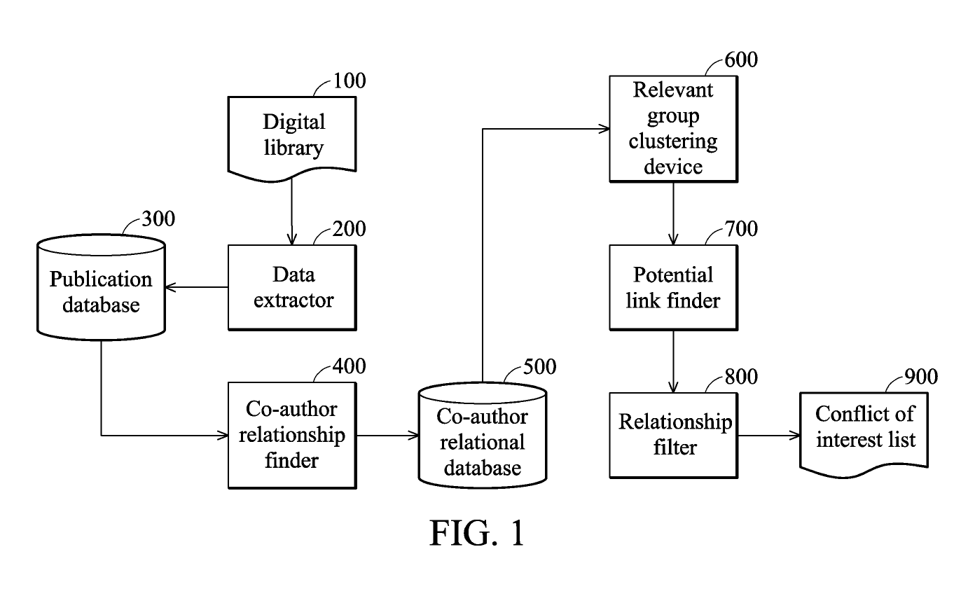

FIG. 1 is a schematic view of an embodiment of a conflict of interest detection system of the present invention.

As shown in FIG. 1, a conflict of interest detection system using social interaction models comprises: digital library 100, data extractor 200, publication database 300, co-author relation finder 400, co-author relation database 500, relevant group clustering device 600, potential link finder 700, relation filter 800, and conflict interest list 900.

The digital library 100, such as DBLP bibliography, provides complete information of a document. The data extractor 200 retrieves a document from the digital library 100, and extracts information of the retrieved document. The publication database 300 stores the extracted of the document. The co-author relation finder 400 establishing co-authorship among documents stored in the publication database 300. The co-author relation database 500 stores the co-author relation information. The relevant group clustering device 600 identifies an authority in a particular field, and clusters researchers connected to the authority as a group, thereby researchers having potential co-author relation are grouped together. The potential link finder 700 identifies researchers having potential co-author relation from the groups established by the relevant group clustering device 600. The relation filter 800 filters out researchers having weaker relation from the group having co-author relation established by the potential link finder, the filtering is implemented based on a number of common friends of the corresponding researchers, a number of collaborative papers, and a date of collaborative publications. The conflict interest list 900 stores the filtered co-author relation data as the conflict of interest list.

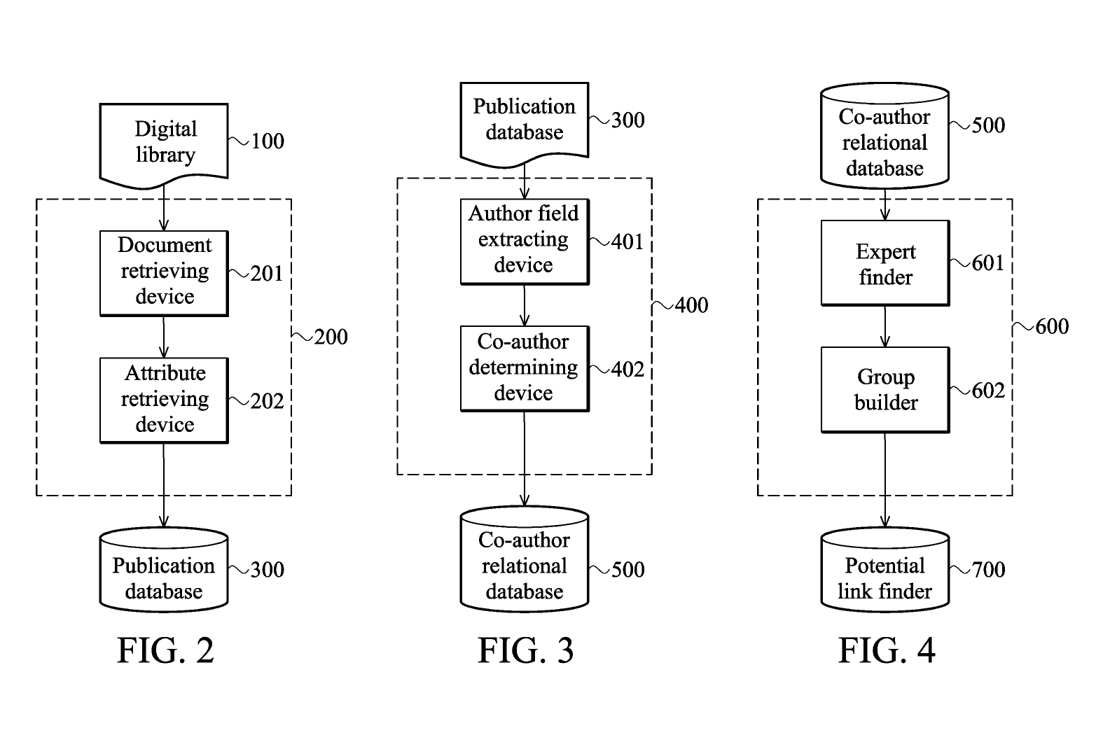

FIG. 2 is a schematic view showing the data extractor of FIG. 1.

The data extractor 200 comprises two devices, i.e., a document retrieving device 201 and an attribute retrieving device 202. The document retrieving device 201 uses a field or a researcher as searching criteria to retrieve the document from the digital library 100, and provides the retrieved document to the attribute retrieving device 202. The attribute retrieving device 202 retrieves attribute information, such as author, title, and date information, of the retrieved document, and stores the retrieved information in the publication database 300.

FIG. 3 is a schematic view showing the co-authorship finder of FIG. 1.

The co-author relation finder 400 comprises two devices, i.e., an author field extracting device 401 and a co-author determining device 402. The author field extracting device 401 extracts data stored in an author field corresponding to the document in the publication database 300, and provides the extracted data to the co-author determining device 402. The co-author determining device 402 calculates co-author relation according to the data extracted from the author field, and stores a calculated result into the co-author relation database 500.

FIG. 4 is a schematic view showing the relevant group clustering device of FIG. 1.

The relevant group clustering device 600 comprises two devices, i.e., an authority finder 601 and a group builder 602. The authority finder 601 designates an authority among these researchers, and establishing a list of the authority. Here, the so-called authority refers to a researcher having been recorded as an author for a number of times exceeding a preset value. The group builder 602 clusters researchers having co-author relation with the authority as a group according to the list of the authority provided by the authority finder 601.

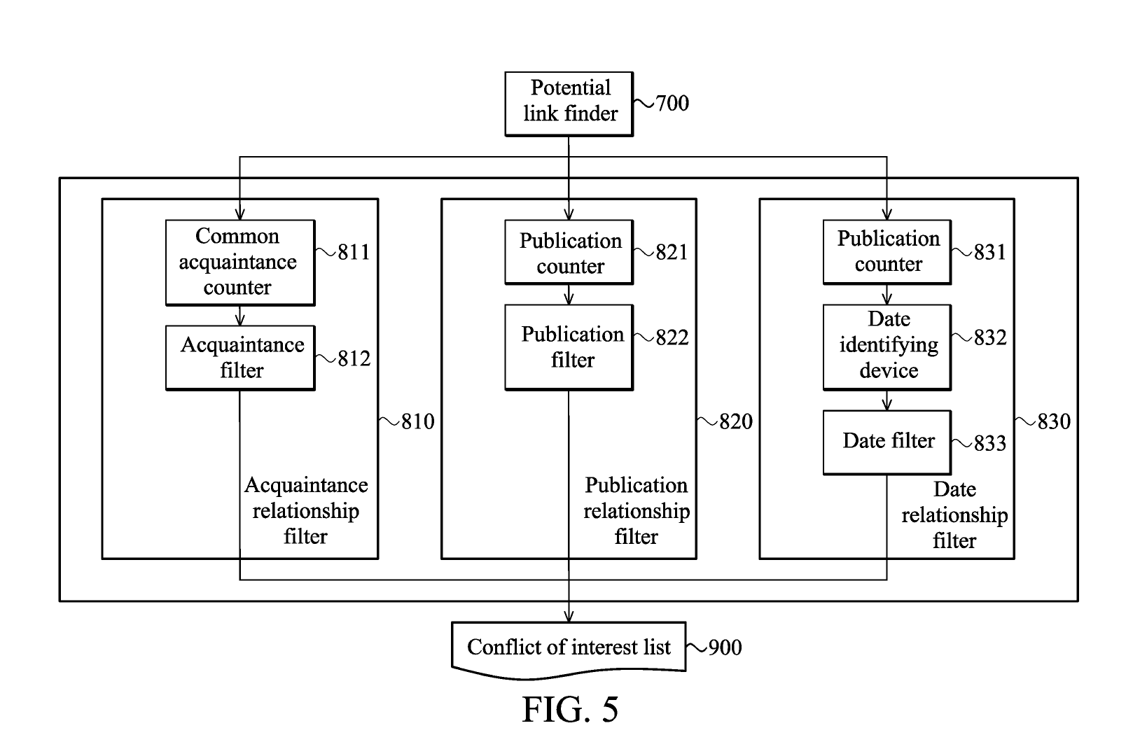

FIG. 5 is a schematic view showing the relation filter of FIG. 1.

The relation filter 800 comprises three devices, i.e., friend relation filter 810, paper relation filter 820, and date relation filter 830. The friend relation filter 810 further comprises two units, i.e., a common friend counter 811 and a friend filter 812. The paper relation filter 820 further comprises two units, i.e., a paper counter 821 and a paper filter 822. The date relation filter 830 further comprises three units, i.e., a paper counter 831, a date identifying device 832 and a date filter 833. When the potential link finder 700 identifies researchers having potential co-author relation, the results obtained by the potential link finder 700 is sent to relation filter 800 for further process. The friend relation filter 810 finds out researchers who are probably friends. The common friend counter 811 calculates the number of common friends according to the common friend relation. The friend filter 812 filters out the co-author relation corresponding to the number of common friends lower than the preset value. The paper relation filter 820 filters out the co-author relation corresponding to the number of collaborative papers less than a preset value. The paper counter calculates the number of collaborative papers according to the collaborative paper relation. The paper filter 822 filters out the co-author relation corresponding to the number of collaborative paper lower than a preset value. The date relation filter 830 determines a number of papers collaboratively published in the same year, and filters out the co-author relation corresponding to a date relation less than a preset value. The paper counter 831 calculates the number of collaborative papers according to the collaborative paper relation. The date identifying device 832 calculates the date relation among the researchers according to the date of collaborative paper. The date filter 833 filters out the co-author relation corresponding to the date relation less than a preset value according to the date relation determined by the date identifying device 832. The filtered co-author relation data is then stored as a conflict of interest list.

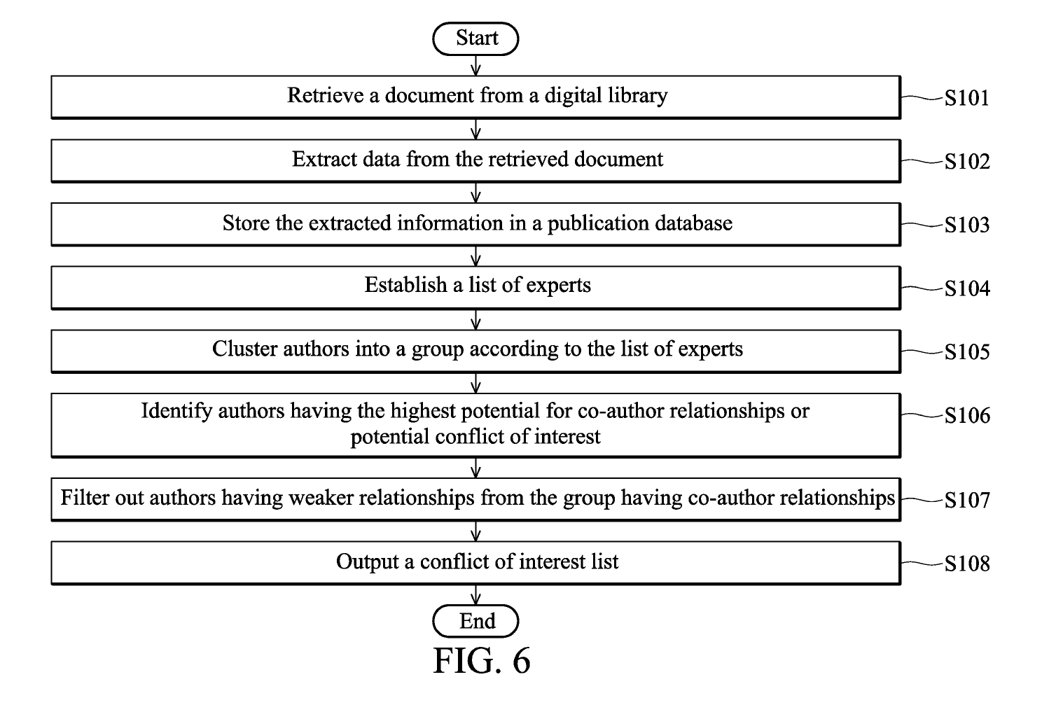

FIG. 6 is a flowchart of an embodiment of a conflict of interest detection method of the present invention.

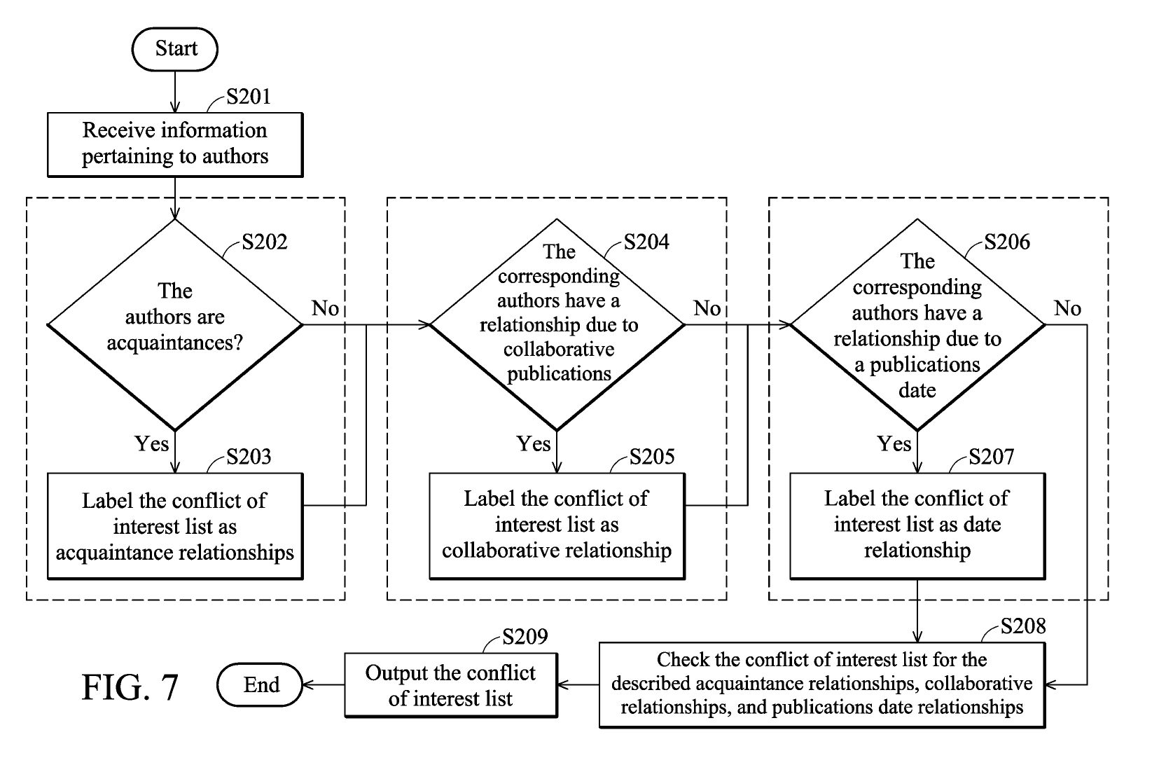

In step S101, a document is retrieved from a digital library. In step S102, data is extracted from the retrieved document. For example, author, title and date information of the document is extracted. In step S103, the extracted information is stored in a publication database. In step S104, the researcher having the most co-authors is designated as an authority among these researchers, and a list of the authority established accordingly. In step S105, researchers having co-authorship with the authority are clustered as a group according to the list of the authority. In step S106, researchers having potential co-author relation or potential conflict of interest are identified. In step S107, researchers having weaker relation are filtered out from the group having co-author relation. Details of this filtering step are shown in FIG. 7. In step S108, the filtered co-author relation data is output as a conflict of interest list.

FIG. 7 is a flowchart showing details of the step of relation filtering of FIG. 6.

In step S201, information pertaining to researchers identified in step S106 is received. In step S202, it is determined whether the researchers are friends. For example, for researcher A and researcher B, when a number of common friends of the researchers A and B is lower than a preset value, then it is regarded that researcher A and researcher B are not friends, otherwise, it is regarded that researcher A and researcher B are friends. When researcher A and researcher B are regarded as friends, the method proceeds to step S203. In step S203, the conflict of interest list is labeled as friend relation, and the method proceeds to step S204. When the researcher A and researcher B are not regarded as friends, the method proceeds from step S202 to step S204 directly. In step S204, it is determined whether the corresponding researchers are connected by collaborative publications. For example, for researcher A and researcher B, when a number of collaborative publications of the researchers A and B is lower than a preset value, then it is regarded that researcher A and researcher B are not connected by collaborative publications, otherwise, it is regarded that researcher A and researcher B are connected by collaborative publications. When researcher A and researcher B are regarded as being connected by collaborative publications, the method proceeds to step S205. In step S205, the conflict of interest list is labeled as collaborative relation, and the method proceeds to step S206. When the researcher A and researcher B are not regarded as being connected by collaborative publications, the method proceeds from step S204 to step S206 directly. In step S206, it is determined whether the corresponding researchers are connected by date of publications. For example, for researcher A and researcher B, when a number of collaborative publications on a particular year of the researchers A and B is lower than a preset value, then it is regarded that researcher A and researcher B do not have date relation, otherwise, it is regarded that researcher A and researcher B have date relation. When researcher A and researcher B are regarded as having date relation, the method proceeds to step S207. In step S207, the conflict of interest list is labeled as date relation, and the method proceeds to step S208. When the researcher A and researcher B are not regarded as friends, the method proceeds from step S206 to step S208 directly. In step S208, the conflict of interest list is checked for the described friend relation, collaborative relation, and date relation. In step S209, the conflict of interest list is output.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A conflict of interest detection system using social interaction models, comprising:
a data extractor, retrieving a document from a digital library, and extracting author, title, and date information of the retrieved document;
a publication database, storing the author, title, and date information of the document;
a co-author relation finder, establishing co-authorship among documents stored in the publication database, and establishing co-author relation among authors corresponding to the document;
a co-author relation database, storing the co-author relation information;
a relevant group clustering device, identifying an authority in a particular field, and clustering researchers connected to the authority as a group, thereby researchers having potential co-author relation are grouped together;
a potential link finder, identifying researchers having potential co-author relation from the groups established by the relevant group clustering device using at least one graph theory algorithm;
a relation filter, filtering out researchers having weaker relation from the group having co-author relation established by the potential link finder, the filtering is implemented based on a number of common friends of the corresponding researchers, a number of collaborative papers, and a date of collaborative publications; and
a conflict interest list, storing the filtered co-author relation data as the conflict of interest list.

2. The conflict of interest detection system using social interaction models of claim 1, wherein the data extractor comprises:
a document retrieving device, using a field or a researcher as searching criteria to retrieve the document from the digital library; and
an attribute retrieving device, retrieving author, title, and date information of the retrieved document, and storing the retrieved information in the publication database.

3. The conflict of interest detection system using social interaction models of claim 1, wherein the co-authorship finder comprises:
an author field extracting device, extracting data stored in an author field corresponding to the document in the publication database; and
a co-author determining device, calculating co-author relation according to the data extracted from the author field, and storing a calculated result into the co-authorship database.

4. The conflict of interest detection system using social interaction models of claim 1, wherein the relevant group clustering device comprises:
an authority finder, designating the researcher having the most co-authors as an authority among these researchers, and establishing a list of the authority;
a group builder, clustering researchers having co-author relation with the authority as a group according to the list of the authority provided by the authority finder.

5. The conflict of interest detection system using social interaction models of claim 1, wherein the relation filter comprises:
a friend relation filter, filtering out the co-author relation corresponding to the number of common friends lower than a preset value;
a paper relation filter, filtering out the co-author relation corresponding to the number of collaborative papers less than a preset value; and
a date relation filter, filtering out the co-author relation corresponding to a date relation less than a preset value.

6. The conflict of interest detection system using social interaction models of claim 5, wherein the friend relation filter further comprises:
a common friend counter, calculating the number of common friends according to the common friend relation; and
a friend filter, filtering out the co-author relation corresponding to the number of common friends lower than the preset value.

7. The conflict of interest detection system using social interaction models of claim 5, wherein the paper relation filter further comprises:
a paper counter, calculating the number of collaborative papers according to the collaborative paper relation; and
a paper filter, filtering out the co-author relation corresponding to the number of collaborative paper lower than a preset value.

8. The conflict of interest detection system using social interaction models of claim 5, wherein the date relation filter further comprises:
a paper counter, calculating the number of collaborative papers according to the collaborative paper relation;
a date identifying device, calculating the date relation among the researchers according to the date of collaborative paper; and
a date filter, filtering out the co-author relation corresponding to the date relation less than a preset value according to the date relation determined by the date identifying device.

9. A conflict of interest detection method using social interaction models, comprising steps of:
providing a digital library for storing documents of a plurality of researchers, wherein the document comprises author and date information;
storing the author and date information of the document in a publication database;
establishing co-author relation among documents stored in the publication database, and storing the co-author relation in a co-author relation database;
clustering researchers into a relevant group according to the relation between two of the researchers in the co-author relation database;
identifying researchers having potential co-author relation or potential conflict of interest according to the relevant group;
filtering out researchers having weaker relation from the group having co-author relation, the filtering is implemented based on a number of common friends of the corresponding researchers, a number of collaborative papers, and a date of collaborative publications; and
outputting the filtered co-author relation data as a conflict of interest list.

10. The conflict of interest detection method using social interaction models of claim 9, further comprising:
using a field or a researcher as searching criteria to retrieve the document from the digital library; and
retrieving author, title, and date information of the retrieved document, and storing the retrieved information into the publication database.

11. The conflict of interest detection method using social interaction models of claim 9, wherein the step of establishing co-author relation further comprises:
retrieving data stored in an author field corresponding to the document in the publication database; and
calculating co-author relation according to the data retrieved from the author field, and storing a calculated result into the co-authorship database.

12. The conflict of interest detection method using social interaction models of claim 9, wherein the step of establishing relevant group further comprises:
designating the researcher having the most co-authors as an authority among these researchers, and establishing a list of the authority;
clustering researchers having co-authorship with the authority as a group according to the list of the authority.

13. The conflict of interest detection method using social interaction models of claim 9, wherein the step of relation filtering further comprises:
filtering out the co-author relation corresponding to the number of common friends lower than a preset value;
filtering out the co-author relation corresponding to the number of collaborative papers less than a preset value; and
filtering out the co-author relation corresponding to a date relation less than a preset value.

14. The conflict of interest detection method using social interaction models of claim 13, further comprising:
calculating the number of common friends according to the common friend relation; and
filtering out the co-author relation corresponding to the number of common friends lower than the preset value.

15. The conflict of interest detection method using social interaction models of claim 13, further comprising:
calculating the number of collaborative papers according to the collaborative paper relation; and
filtering out the co-author relation corresponding to the number of collaborative paper lower than a preset value.

16. The conflict of interest detection method using social interaction models of claim 13, further comprising:
calculating the number of collaborative papers according to the collaborative paper relation;
calculating the date relation among the researchers according to the date of collaborative paper; and
filtering out the co-author relation corresponding to the date relation less than a preset value according to the date relation determined by the date identifying device.
